(19) United States
(12) Patent Application Publication
(10) Pub. No.: US 2026/0253382 A1
(43) Pub. Date: Aug. 27, 2026

(54) LARGE-SCALE FOUNDATION MODEL FOR SUBJECT, RELATION, AND OBJECT PARSING IN IMAGES

(71) Applicant: Samsung Electronics Co., Ltd., Suwon-si (KR)

(72) Inventors: Divya Choudhary, San Jose, CA (US); Monami Banerjee, Santa Clara, CA (US)

(21) Appl. No.: 19/063,455

(22) Filed: Feb. 26, 2025

(51) Int. Cl. G06V 10/764; G06F 40/279; G06V 10/766; G06V 10/774

(52) U.S. Cl. CPC G06V 10/764; G06F 40/279; G06V 10/766; G06V 10/774

(57) ABSTRACT

A method includes obtaining, using at least one processing device of an electronic device, training images and captions. The method also includes preparing, using the at least one processing device, a training dataset based on the training images, the captions, and semantic knowledge of a large language model. In addition, the method includes training, using the at least one processing device, a machine learning model to determine entity categories and relations between entities in input images based on the training dataset, wherein the entities include subjects and objects captured in the input images.

### TECHNICAL FIELD

This disclosure relates generally to machine learning systems and processes. More specifically, this disclosure relates to a large-scale foundation model for subject, relation, and object parsing in images.

### BACKGROUND

Image parsing aims to detect objects and associated relations in captured images. Despite various attempts at image parsing, performance is still far from useful in real-world scenarios. One major obstacle here is the available data for use in training machine learning models. For example, one available dataset has only 150 object categories and 50 relations, and another available dataset has only 200 frequent entity classes and 100 frequent predicate classes. Datasets can also suffer from long-tailed distributions, meaning machine learning models trained on these datasets are biased towards common general categories and overlook less-frequent more-informative categories. The smaller closed-set taxonomies of these datasets make the resulting machine learning models limited in their ability to recognize novel objects outside of their training corpora.

### SUMMARY

This disclosure relates to a large-scale foundation model for subject, relation, and object parsing in images.

In a first embodiment, a method includes obtaining, using at least one processing device of an electronic device, training images and captions. The method also includes preparing, using the at least one processing device, a training dataset based on the training images, the captions, and semantic knowledge of a large language model. In addition, the method includes training, using the at least one processing device, a machine learning model to determine entity categories and relations between entities in input images based on the training dataset. The entities include subjects and objects captured in the input images. A non-transitory machine-readable medium may include instructions that when executed cause at least one processor to perform the method of the first embodiment.

In a second embodiment, an apparatus includes at least one processing device configured to obtain training images and captions. The at least one processing device is also configured to prepare a training dataset based on the training images, the captions, and semantic knowledge of a large language model. In addition, the at least one processing device is configured to train a machine learning model to determine entity categories and relations between entities in input images based on the training dataset. The entities include subjects and objects captured in the input images.

Any one or any combination of the following features may be used with the first or second embodiment. The machine learning model may be trained by, for each training image and an associated prompt in the training dataset, encoding the training image and the associated prompt; decoding the encoded image and the encoded prompt; mapping the decoded image and the decoded prompt into one or more entity pairs based on entity embeddings; determining a category for a specified subject and a category for a specified object in each entity pair; determining a corresponding bounding box for each of the specified subject and the specified object; and determining a category for a relation between the specified subject and the specified object based on the entity embeddings. The machine learning model may be trained by, for each training image and an associated prompt in the training dataset, training a prompt to phrase questions such that the machine learning model points to an entity pair present in the training image. The machine learning model may be trained based on a regression algorithm configured to support an open taxonomy or open vocabulary for relation and entity categorizations. The training dataset may be prepared by selecting, using a caption classifier, reliable captions from the captions; prompting the large language model to obtain subject-object-verb (SOV) triplets from sentences; generating an SOV triplet dataset for the reliable captions; and identifying nouns in the SOV triplet dataset and corresponding bounding boxes in respective training images. The machine learning model may include an entity decoder and a relation decoder, the entity decoder may be configured to generate three distinct outcomes for each prompt associated with a corresponding training image, and the relation decoder may be configured to generate relation embeddings based on the three distinct outcomes until relation embeddings for a last prompt are generated. Each of the entity decoder and the relation decoder may include a two-way transformer configured to bi-directionally process and pass information such that prompts learn from the determined entity categories and the determined relations between the entities in the training images.

In a third embodiment, a method includes obtaining, using at least one processing device of an electronic device, an image and associated prompts, where the image includes multiple entities. The method also includes processing, using the at least one processing device, the image and the associated prompts using a machine learning model. The machine learning model is trained to map an encoded image and encoded prompts into one or more entity pairs, where each entity pair includes a subject and an object. The machine learning model is also trained to determine a relation between the subject and the object in each entity pair. In addition, the method includes generating, using the at least one processing device, one or more entity categories and one or more relation categories associated with the image based on the one or more entity pairs and the relation associated with each of the one or more entity pairs. An apparatus may include at least one processing device configured to perform the method of the third embodiment. A non-transitory machine-readable medium may include instructions that when executed cause at least one processor to perform the method of the third embodiment.

Any one or any combination of the following features may be used with the third embodiment. The machine learning model may be trained by obtaining training images and captions; preparing a training dataset based on the training images, the captions, and semantic knowledge of a large language model; and training the machine learning model based on the training dataset. The machine learning model may be trained by, for each training image and an associated prompt in the training dataset, encoding the training image and the associated prompt; decoding the encoded image and the encoded prompt; mapping the decoded image and the decoded prompt into one or more entity pairs based on entity embeddings; determining a category for a specified subject and a category for a specified object in each entity pair; determining a corresponding bounding box for each of the specified subject and the specified object; and determining a category for a relation between the specified subject and the specified object based on the entity embeddings. The training dataset may be prepared by selecting, using a caption classifier, reliable captions from the captions; prompting the large language model to obtain subject-object-verb (SOV) triplets from sentences; generating an SOV triplet dataset for the reliable captions; and identifying nouns in the SOV triplet dataset and corresponding bounding boxes in respective training images. A prompt of the machine learning model may be trained to phrase questions such that the machine learning model points to an entity pair present in the image. The machine learning model may be trained based on a regression algorithm configured to support an open taxonomy or open vocabulary for relation and entity categorizations.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings:

FIG. 1 illustrates an example network configuration including an electronic device in accordance with this disclosure;

FIG. 2 illustrates an example architecture of a machine learning model for image parsing in accordance with this disclosure;

FIG. 3 illustrates an example pipeline for creating a large-scale training dataset for a machine learning model for image parsing in accordance with this disclosure;

FIG. 4 illustrates an example method for training a machine learning model to perform image parsing in accordance with this disclosure; and

FIG. 5 illustrates an example method for using a trained machine model to perform image parsing in accordance with this disclosure.

### DETAILED DESCRIPTION

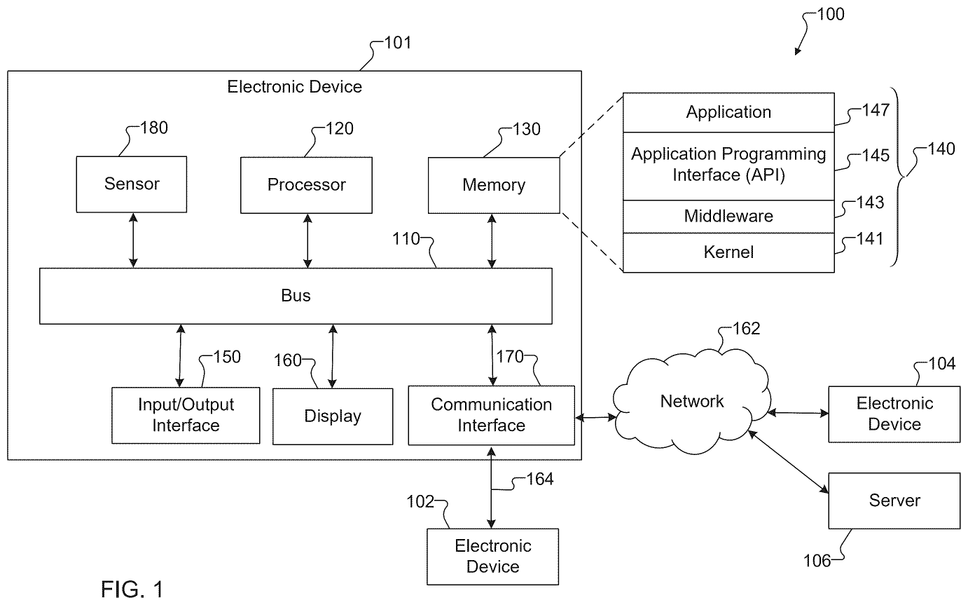

FIGS. 1 through 5, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure.

As noted above, image parsing aims to detect objects and associated relations in captured images. Despite various attempts at image parsing, performance is still far from useful in real-world scenarios. One major obstacle here is the available data for use in training machine learning models. For example, one available dataset has only 150 object categories and 50 relations, and another available dataset has only 200 frequent entity classes and 100 frequent predicate classes. Datasets can also suffer from tong-tailed distributions, meaning machine learning models trained on these datasets are biased towards common general categories and overlook less-frequent more-informative categories. The smaller closed-set taxonomies of these datasets make the resulting machine learning models limited in their ability to recognize novel objects outside of their training corpora.

As particular examples of problems being experienced, small-scale datasets often suffer from limitations due to manual annotations, long-tailed distributions, and closed-set taxonomies. For semantic relation detection, manually-annotated data is often used for supervised training. However, manual annotations demand excessive time and cost and introduce human bias, resulting in noise in the training datasets and causing confusion in the model training. In a long-tailed distribution, high-frequency events or observations are concentrated in a “head” portion of the distribution, followed by a large number of low-frequency events forming a “tail.” Thus, in the long-tailed distribution for entity and relation categories, the frequent/simple/common/general categories (such as “on” or “in”) with thousands of samples are concentrated in the head, whereas some of the less-frequent but more-informative categories (such as “standing on” or “writing on”) with only a few examples are present in the “tail.” Such long-tailed distributions often misguide trained models to output vague or incorrect predictions. Closed-set taxonomies often limit the ability of models to recognize novel objects outside of their training corpora.

In addition to challenges associated with training datasets, the resulting models themselves often have their own limitations. For example, current state-of-the-art machine learning-based image parsing models are often focused only on solving specific tasks of image understanding, such as scene graph generation (SGG), scene understanding, human object interaction (HOI), and image captioning. Since these models are trained based on small-scale training datasets utilizing closed-set taxonomies, these models are further constrained to focus only on fixed taxonomies. Thus, there is no single model that can achieve all of these downstream tasks on a taxonomy that is sufficiently large to serve multiple or all real-world applications.

In addition, current state-of-the-art models often require high computational complexity. For example, SGG models predict semantic relations in two stages, first by detecting an entity present in an image and then by identifying the relation present among each pair of entities. Hence, these models need to consider all of the O(n²) entity pairs, where n is an upper bound on the possible number of the entities. This can result in significant computational overhead.

While some multimodal language models have been utilized, these multimodal language models often require a huge number of parameters (such as billions of parameters) in order to yield acceptable performance. Because of their size and complexity, multimodal language models typically cannot be deployed easily, at least not in a cost-effective manner.

This disclosure provides various techniques related to large-scale foundation models for subject, relation, and object parsing in images. As described in more detail below, training images and captions can be obtained, and a training dataset can be prepared based on the training images, the captions, and semantic knowledge of a large language model. A machine learning model can be trained to determine entity categories and relations between entities in input images based on the training dataset. The entities include subjects and objects captured in the input images.

After training, an image and associated prompts can be obtained, and the image can include multiple entities. The image and the associated prompts can be processed using the machine learning model, and the machine learning model can be trained to map an encoded image and encoded prompts into one or more entity pairs. Each entity pair can include a subject and an object, and the machine learning model can be trained to determine a relation between the subject and the object in each entity pair. One or more entity categories and one or more relation categories associated with the image can be generated based on the one or more entity pairs and the relation associated with each of the one or more entity pairs.

In this way, the described techniques support more effective training of machine learning models that can be used to provide improved image parsing. For example, a machine learning model may be trained to more effectively and accurately detect sematic relations between entities in input images based on weakly-supervised training using a large-scale training dataset with an open taxonomy-based approach. Also, a machine learning model can predict entity relations based on analyzing edges first and not entities first, thereby reducing the computational complexity and time required for training and inferencing.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may train and/or use a machine learning model for performing image parsing, such as by using a foundation model to perform semantic relation detection in images.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, train and/or use a machine learning model for performing image parsing. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232(RS-232 ), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may train and/or use a machine learning model for performing image parsing, such as by using a foundation model to perform semantic relation detection in images.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

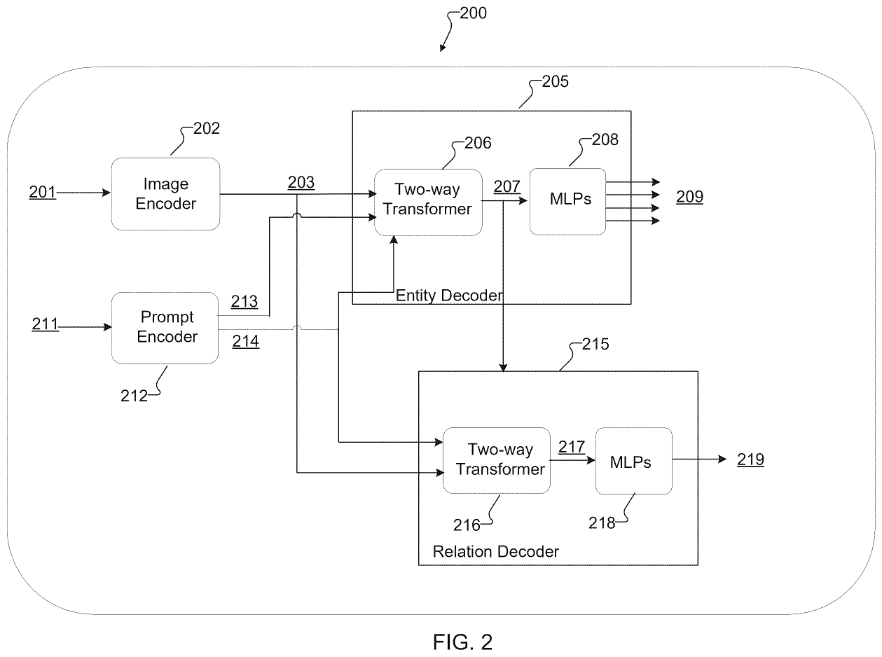

FIG. 2 illustrates an example architecture of a machine learning model 200 for image parsing in accordance with this disclosure. For ease of explanation, the foundation model 200 shown in FIG. 2 is described as being implemented in or supported by the electronic device 101 in the network configuration 100 of FIG. 1. However, the foundation model 200 shown in FIG. 2 could be used with any other suitable device(s) and in any other suitable system(s), such as when the foundation model 200 is implemented on or supported by the server 106. As a particular example, the machine learning model 200 may be trained by the server 106 and deployed to the electronic device 101 for use.

In some embodiments, the machine learning model 200 may be a foundation model for performing semantic relation detection in images for use in one or more downstream tasks. As shown in FIG. 2, the foundation model 200 generally includes an image encoder 202, a prompt encoder 212, an entity decoder 205, and a relation decoder 215. The image encoder 202 generally operates to receive and process input images 201. The prompt encoder 212 generally operates to receive and process input prompts 211 associated with the input images 201.

Each input image 201 may include one or more entities. An entity includes at least a subject and an object. A subject refers to a primary entity that is a main focus or that performs an action in an input image 201. An object refers to an entity in the input image 202 that is not the main focus but that interacts with or is relevant to the subject. A verb refers to the action or relationship depicted between a subject and an object. Thus, a “subject-object-verb triplet” (SOV triplet) refers to a structure used in natural language processing (NLP) and other processing to represent a basic structure or relationship within an image. Here, a relation refers to a spatial, contextual, semantic, or functional manner in which entities are connected, related, or interact with each other in a given image. Here, a “subject-relation-object triplet” is similar to an SOV triplet but differs in that it may include a non-verb predicate relation. For the purposes of this disclosure, the phrase “SOV triplet” may be interchangeably used with the term “subject-relation-object triplet” unless otherwise specified.

Each input image 201 may be obtained from any suitable source(s), such as when the input image 201 is captured using at least one camera or other imaging sensor 180 of the electronic device 101 during an image capture operation. Depending on the implementation, a single imaging sensor 180 may be used to capture one or more input images 201, or multiple imaging sensors 180 may be used to capture one or more input images 201.

The input prompts 211 may include a number of prompts (and possibly a large number of prompts, such as up to or more than 1,000 prompts) associated with each input image 201. In some cases, the input prompts 211 may include user queries or requests related to the contents of each input image 201. Also, in some cases, the input prompts 211 represent learnable prompts that may be trained how to phrase questions so that the foundation model 200 points to an entity pair (such as a subject-object pair) in an input image 201. In some cases, a learnable prompt may be a parameter that can be trained (updated or adjusted during fine-tuning) to improve performance of the foundation model 200. Hence, during training, the input prompts 211 can be updated or adjusted to find the best representations of prompts that optimize task performance at hand. For example, an input prompt 211 may be trained to ask in detail “what activity is present in the upper left corner of the image?” In some embodiments, the input prompts 211 are not learned in a textual representation but as vectors and initialized randomly. That is, the input prompts 211 may be initialized as random vectors in an embedding space of the foundation model 200. In particular embodiments, the input prompts 211 may not be entered by users and may instead become hidden parameters of the model 200 during inferencing.

The image encoder 202 and the prompt encoder 212 respectively encode the input images 201 and the prompts 211. For example, the image encoder 202 may process raw or other image data of each input image 201 and generate image embeddings 203 representing the image data. As a particular example, the image encoder 202 can convert pixel-level information on each input image 201 into a set of features representing, for instance, edges, textures, colors, or full or parts of entities. The image encoder 202 may output the image embeddings 203 including the identified features in a vector form. In some embodiments, the image encoder 202 may utilize convolutional layers in a convolutional neural network (CNN) or transformer to create the image embeddings 203. Overall, the image encoder 202 can extract, from each input image 201, features that may assist in identifying entities, entity locations, and/or entity relations into an embedding space.

The prompt encoder 212 may process the input prompts 211 into prompt embeddings and positional encodings. The prompt embeddings may include vectors or sequences of vectors that capture the semantic intent of the input prompts 211. The positional encodings provide information about the positions of elements (or tokens) in the input prompts 211 to assist one or more transformers in understanding the order of the elements in the input prompts 204.

The entity decoder 205 generally operates to receive and decode the image embeddings 203, prompt embeddings 213, and positional encodings 214 using a two-way transformer 206 in order to generate entity embeddings 207. The entity decoder 205 also generally operates to process the entity embeddings 207 using one or more multilayer perceptrons (MLPs) 208 in order to generate entity categories and corresponding entity locations (bounding boxes) 209 based on the entity embeddings 207. In this example, the two-way transformer 206 can process the image embeddings 203, prompt embeddings 213, and positional encodings 214 and map them into interacting entity pairs (subject-object pairs) present in the input images 201. In some embodiments, the transformer 206 can be trained using a regression algorithm to generate three distinct outcomes for each input prompt 211. That is, the two-way transformer 206 may perform multiple (such as three) queries per input prompt 212 and output entity embeddings 207 that represent multiple (such as three) distinct outcomes for each input prompt 211. The multiple queries provide the model 200 with the ability to consider synonyms not included in the training dataset, thereby allowing open taxonomy-based semantic relation detection. The entity embeddings 207 are fed to the MLPs 208 and the relation decoder 215. The MLPs 208 can process the entity embeddings 207 and the predict entity categories and corresponding bounding boxes 209 of the entity pairs present in the input images 201.

The relation decoder 215 generally operates to receive and decode the image embeddings 203, positional encodings 214, and entity embeddings 207. In this example, the relation decoder 215 includes a two-way transformer 216 and one or more MLPs 218. The two-way transformer 216 may be similar to the two-way transformer 206. For example, the two-way transformer 216 may receive the image embeddings 203, positional encodings 214, and entity embeddings 207 and generate relation embeddings 217 based on those inputs. The relation embeddings 217 are fed to the MLPs 218, which can predict relation categories. As the entity embeddings 207 include multiple outcomes per input prompt 211, the MLPs 208, 218 here can makes make multiple (such as three) predictions per input prompt 211. For example, if K prompts are input to the model 200, the model 200 can make 3K predictions per input image 201. The relation decoder 215 can also predict the entity relations based directly on the subject-object pairs determined to be present in the input images 201 by the entity decoder 205.

In some embodiments, the foundation model 200 can perform semantic relation prediction based on edges (the subject-object pairs determined to be present in the input images 201), and the model 200 need not first identify each entity in the input images 201 and then determine each entity's relation with every other entity in the input images 201 (as is done in existing image parsing models, such as SGG models). As previously mentioned, SGG models compare every entity (a vertex in a scene graph) in an image with every other entity in the image in order to determine if there is a relation (edge) between them. This leads to O(n²) complexity, where n is an upper bound on a possible number of entities in the image. Thus, the time it takes to process the image can grow quadratically with an increase in n. By determining entity relations based on edges, the foundation model 200 significantly reduces the computational time complexity to O(n). Further, direct semantic relation determination reduces or eliminates time and resource waste in determining a negligible edge probability.

Moreover, the foundation model 200 can produce more accurate semantic relation predictions than existing SGG models based on the operation of the two-way transformers 206, 216. This is because the two-way transformers 206, 216 can be configured to bi-directionally process and pass information such that the foundation model 200 can consider both past and future contexts within sequences of elements or tokens in the input images 201 and/or the prompts 211. For example, the input prompts 211 can learn from determined entity categories and corresponding bounding boxes 209 how to phrase questions so that the model 200 points to a subject-object pair present in the images, and the model 200 can learn from the operations of the learnable prompts.

By providing a suitable regression or other training algorithm that supports an open taxonomy or vocabulary for relations and entities, the foundation model 200 can learn to predict correct embeddings for entities and relations that can later be mapped to their nearest words in a language of interest. By reducing the time complexity based on direction relation detection based on relevant edges, the foundation model 200 can consider a graph in an edge-first manner, rather than the typical vertex-first manner. This can help to resolve problems with fully-connected graphs, where many of the edge probabilities may be found to be negligible.

Although FIG. 2 illustrates one example of an architecture of a machine learning model 200 for image parsing, various changes may be made to FIG. 2. For example, various components or operations in FIG. 2 may be combined, further subdivided, replicated, rearranged, or omitted according to particular needs. Also, various additional components or functions may be used in FIG. 2. In addition, the specific foundation model 200 described above is for illustration and explanation only. Various image parsing models, albeit for specific downstream tasks, have been developed, and additional image parsing models are sure to be developed in the future. This disclosure is not limited to any specific implementation of a foundation model 200 or even to use within an image processing pipeline. In general, the techniques for machine learning-based image parsing described in this patent document may be used in any suitable image processing model, pipeline, or other architecture.

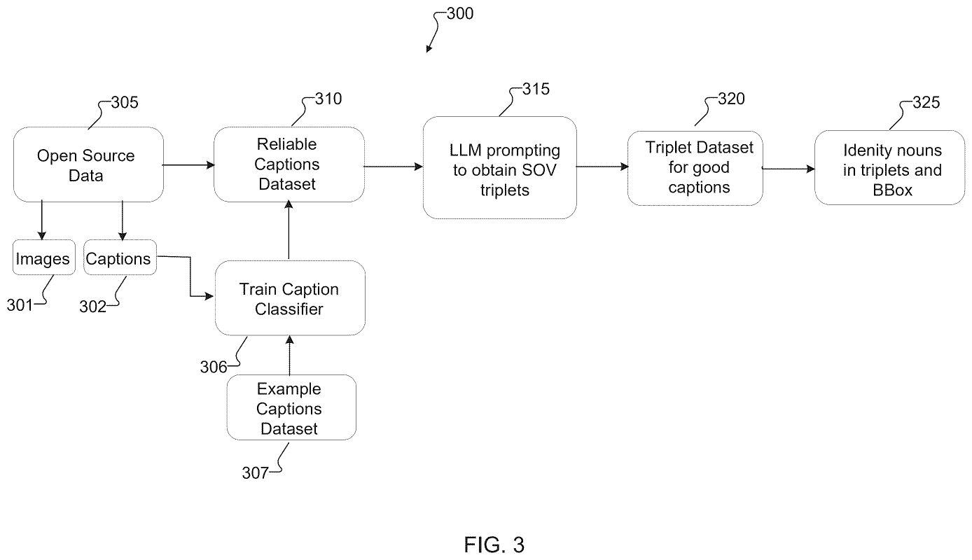

FIG. 3 illustrates an example pipeline 300 that supports creation of a large-scale training dataset for a large-scale image parsing model in accordance with this disclosure. For ease of explanation, the pipeline 300 shown in FIG. 3 is described as being implemented in or supported by the server 106 in the network configuration 100 of FIG. 1. However, the pipeline 300 shown in FIG. 3 could be used with any other suitable device(s) and in any other suitable system(s), such as when the pipeline 300 is implemented on or supported by the electronic device 101. Also, while described as being used to create training data for the machine learning model 200 shown in FIG. 2, the pipeline 300 shown in FIG. 3 may be used with any other suitable machine learning model.

As shown in FIG. 3, the pipeline 300 generally obtains training images 301 and captions 302, such as from one or more publicly-available open-source data sources. For example, the pipeline 300 may collect images 301 and captions 302 from the Large-scale Artificial Intelligence Open Network 5 Billion-en (LAION-5B-en) dataset, which is an English subset of the LAION-5B dataset that includes more than 5 billion image-text pairs.

The collected images 301 and captions 302 undergo various operations in the pipeline 300. For example, the collected captions 302 may be provided to a training operation 306, which generally operates to train a caption classifier to select reliable captions based on the collected captions. In some embodiments, the caption classifier may be trained using at least one caption dataset 307 having reliable captions. In some cases, the caption dataset 307 may include the Common Objects in Context-captions (COCO) captions dataset, which includes more than 120,000 images containing complex scenes with multiple objects in their natural contexts and each image being paired with five different captions with manual annotations. The trained caption classifier may be used to select reliable captions from the captions 302. In some embodiments, the caption classifier may use filters to reduce noise (such as human biases exhibited in manual annotations) and select relevant image-caption pairs.

The reliable captions can be provided to a dataset generation operation 310, which generally operates to generate a reliable captions dataset based on the selected reliable captions. For example, the processor 120 of the server 106 may collect the reliable captions (the captions identified as correctly describing corresponding images by the classifier) and compile the reliable captions into the reliable caption dataset. The reliable caption dataset may be automatically updated as appropriate. The reliable caption dataset may also include the corresponding images. In some embodiments, the reliable caption dataset may include numerous reliable captions, such as up to approximately 15 million selected reliable captions or more. The reliable captions dataset can be provided to a large language model 315, which can be prompted to obtain SOV triplets from sentences based on the large language model's semantic knowledge. In some embodiments, this can be done in an off-line manner. The large language model 315 represents any suitable large language model, such as a standard open-source or proprietary large language model.

The SOV triplets may be provided to another dataset generation operation 320, which generally operates to generate an SOV triplet dataset for the reliable captions. For example, the processor 120 of the server 106 may aggregate the identified SOV triplets into a structured dataset. The processor 120 may also perform checks or apply filters to ensure the data integrity or quality. The SOV triplet dataset may include metadata such as source, context, or additional information associated with each SOV triplet. The SOV triplet dataset may be automatically updated, corrected, or revised as appropriate. In some embodiments, the SOV triplet dataset may include numerous SOV triplets, such as up to 40 million SOV triplets or more. The SOV triplet dataset then be provided to an entity prediction operation 325, which generally operates to identify nouns in the SOV triplets and corresponding bounding boxes. In some cases, this may be done utilizing the semantic knowledge and open taxonomy capabilities of the large language model 315.

A large-scale training dataset is thus created and continually updated in a self-supervised manner. By using the large-scale dataset including more than 5 billion image-text pairs, the pipeline 300 allows the caption classifier to be trained to select and generate a large-scale reliable caption dataset. By utilizing the large language model, the large-scale training dataset is created based on the semantic knowledge and open-taxonomy capability of the large language model in an off-line manner. The off-line utilization of the large language model allows the foundation model 200 to have a small final size (as compared to the existing image parsing models) since the foundation model 200 is not required to be built upon the large language model.

Although FIG. 3 illustrates one example of a pipeline 300 that supports self-supervised creation of a large-scale training dataset, various changes may be made to FIG. 3. For example, various components or operations in FIG. 3 may be combined, further subdivided, replicated, rearranged, or omitted according to particular needs. Also, various additional components or functions may be used in FIG. 3. In addition, the specific pipeline 300 described above is for illustration and explanation only. Various image processing pipelines have been developed, and additional training dataset creation pipelines are sure to be developed in the future. This disclosure is not limited to any specific implementation of a pipeline 300 or even to use within a training dataset pipeline. In general, the techniques for self-supervised creation of a large-scale training dataset described in this patent document may be used in any other training dataset creation pipeline or other architecture.

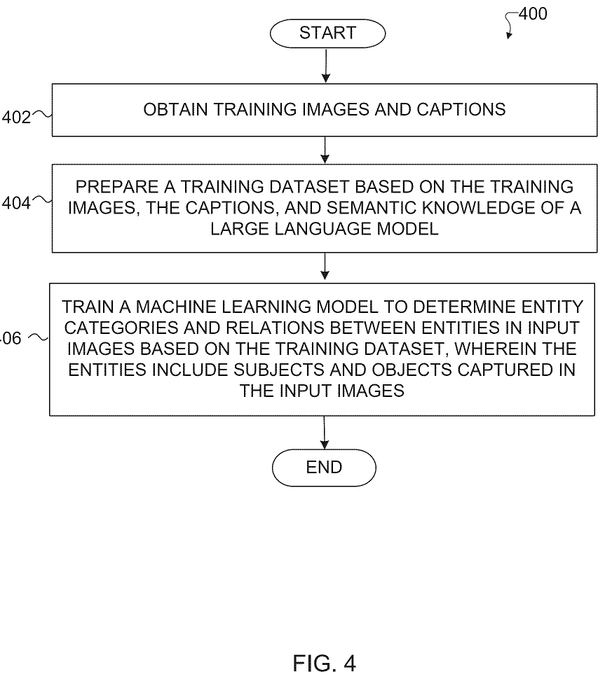

FIG. 4 illustrates an example method 400 for training a machine learning model to perform image parsing in accordance with this disclosure. For ease of explanation, the method 400 shown in FIG. 4 is described as being performed by the server 106 in the network configuration 100 of FIG. 1, where the server 106 can train a machine learning model 200 having the structure as shown in FIG. 2. However, the method 400 shown in FIG. 4 could be performed by any other suitable device(s) and in any other suitable system(s), such as when the method 400 is performed using the electronic device 101. The method 400 could also be used to train any other suitable machine learning model.

As shown in FIG. 4, training images and captions are obtained at step 402. This may include, for example, the processor 120 of the server 106 obtaining multiple sets 302 of training images and captions, such as from one or more publicly-available open-source data sources or other data source(s). A training dataset based on the training images, the captions, and semantic knowledge of a large language model is prepared at step 404. This may include, for example, the processor 120 of the server 106 selecting reliable captions from the obtained captions using a caption classifier, prompting the large language model 315 to obtain subject-object-verb (SOV) triplets from sentences, generating an SOV triplet dataset for the reliable captions, and identifying nouns in the SOV triplet dataset and corresponding bounding boxes in respective training images.

Training of a machine learning model is performed at step 406. This may include, for example, the processor 120 of the server 106 training the machine learning model 200 using the training dataset. The machine learning model 200 can be trained to determine entity categories and relations between entities in input images based on the training dataset. In some cases, training of the machine learning model 200 can be performed for each training image and an associated prompt in the training dataset. For instance, the training image and the associated prompt can be encoded, the encoded image and encoded prompt may be decoded, the decoded image and the decoded prompt may be mapped into one or more entity pairs, a category for a specified subject and a category for a specified object in each entity pair may be determined, a corresponding bounding box for each of the specified subject and the specified object may be determined, and a category for a relation between the specified subject and the specified object may be determined based on the entity embeddings. In some cases, a prompt can be trained to phrase questions such that the machine learning model 205 points to an entity pair present in each training image.

Although FIG. 4 illustrates one example of a method 400 for training a machine learning model 200 to perform image parsing, various changes may be made to FIG. 4. For example, while shown as a series of steps, various steps in FIG. 4 may overlap, occur in parallel, occur in a different order, or occur any number of times (including zero times). As a particular example, various ones of the steps 402-406 may occur repeatedly during different training iterations of the machine learning model 200.

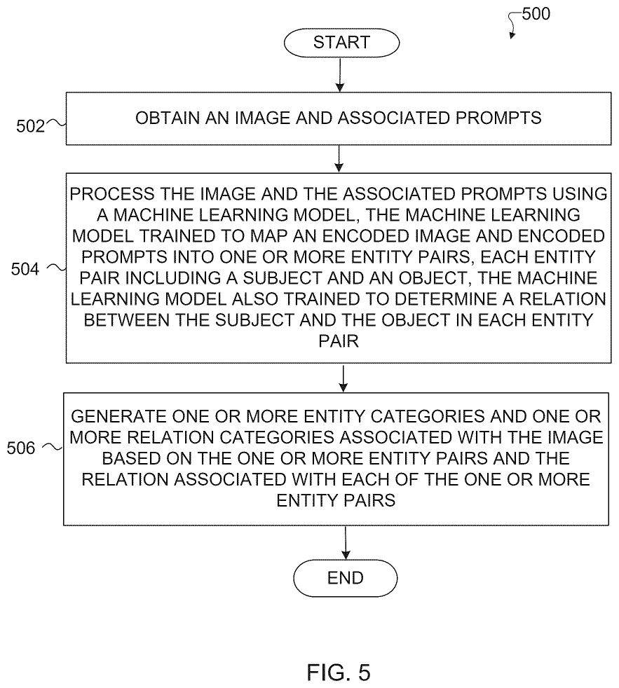

FIG. 5 illustrates an example method 500 for using a trained machine learning model to perform image parsing in accordance with this disclosure. For ease of explanation, the method 500 shown in FIG. 5 is described as being performed by the electronic device 101 in the network configuration 100 of FIG. 1, where the electronic device 101 can use the machine learning model 200 shown in FIG. 2. However, the method 500 shown in FIG. 5 could be performed by any other suitable device(s) and in any other suitable system(s), such as when the method 500 is performed using the server 106. The method 500 could also be used with any other suitable machine learning model.

As shown in FIG. 5, an image and associated prompts are obtained at step 502. This may include, for example, the processor 120 of the electronic device 101 obtaining an input image 201 and input prompts 211. The image may include multiple entities. The image and the associated prompts are processed using a machine learning model at step 504. This may include, for example, the processor 120 of the electronic device 101 using the machine learning model to map an encoded version of the image and encoded versions of the prompts into one or more entity pairs, where each entity pair can include a subject and an object. The machine learning model can be also trained to determine a relation between the subject and the object in each entity pair. The machine learning model may be trained as shown in FIG. 4 and discussed above. One or more entity categories and one or more relation categories may be generated at step 506. This may include, for example, the processor 120 of the electronic device 101 identifying the one or more entity categories and the one or more relation categories predicted by the machine learning model 200. The one or more relation categories may be associated with the image based on the one or more entity pairs and the relation associated with each of the one or more entity pairs.

Although FIG. 5 illustrates one example of a method 500 for using a trained machine learning model 200 to perform image parsing, various changes may be made to FIG. 5. For example, while shown as a series of steps, various steps in FIG. 5 may overlap, occur in parallel, occur in a different order, or occur any number of times (including zero times).

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, training images and captions;
preparing, using the at least one processing device, a training dataset based on the training images, the captions, and semantic knowledge of a large language model; and
training, using the at least one processing device, a machine learning model to determine entity categories and relations between entities in input images based on the training dataset, wherein the entities include subjects and objects captured in the input images.

2. The method of claim 1, wherein training the machine learning model comprises, for each training image and an associated prompt in the training dataset:
encoding the training image and the associated prompt;
decoding the encoded image and the encoded prompt;
mapping the decoded image and the decoded prompt into one or more entity pairs based on entity embeddings;
determining a category for a specified subject and a category for a specified object in each entity pair;
determining a corresponding bounding box for each of the specified subject and the specified object; and
determining a category for a relation between the specified subject and the specified object based on the entity embeddings.

3. The method of claim 1, wherein training the machine learning model comprises, for each training image in the training dataset:
training the associated prompt to phrase questions such that the machine learning model points to an entity pair present in the training image.

4. The method of claim 1, wherein training the machine learning model comprises:
training the machine learning model based on a regression algorithm configured to support an open taxonomy or open vocabulary for relation and entity categorizations.

5. The method of claim 1, wherein preparing the training dataset comprises:
selecting, using a caption classifier, reliable captions from the captions;
prompting the large language model to obtain subject-object-verb (SOV) triplets from sentences;
generating an SOV triplet dataset for the reliable captions; and
identifying nouns in the SOV triplet dataset and corresponding bounding boxes in respective training images.

6. The method of claim 1, wherein:
the machine learning model comprises an entity decoder and a relation decoder;
the entity decoder is configured to generate three distinct outcomes for each prompt associated with a corresponding training image; and
the relation decoder is configured to generate relation embeddings based on the three distinct outcomes until relation embeddings for a last prompt are generated.

7. The method of claim 6, wherein each of the entity decoder and the relation decoder includes a two-way transformer configured to bi-directionally process and pass information such that prompts learn from the determined entity categories and the determined relations between the entities in the training images.

8. An apparatus comprising:
at least one processing device configured to:
obtain, using at least one processing device of an electronic device, training images and captions;
prepare, using the at least one processing device, a training dataset based on the training images, the captions, and semantic knowledge of a large language model; and
train, using the at least one processing device, a machine learning model to determine entity categories and relations between entities in input images based on the training dataset, wherein the entities include subjects and objects captured in the input images.

9. The apparatus of claim 8, wherein, to train the machine learning model, the at least one processing device is configured, for each training image and an associated prompt in the training dataset:
encode the training image and the associated prompt;
decode the encoded image and the encoded prompt;
map the decoded image and the decoded prompt into one or more entity pairs based on entity embeddings;
determine a category for a specified subject and a category for a specified object in each entity pair;
determine a corresponding bounding box for each of the specified subject and the specified object; and
determine a category for a relation between the specified subject and the specified object based on the entity embeddings.

10. The apparatus of claim 8, wherein to train the machine learning model, the at least one processing device is configured, for each training image in the training dataset, to:
training the associated prompt to phrase questions such that the machine learning model points to an entity pair present in the training image.

11. The apparatus of claim 8, wherein to train the machine learning model, the at least one processing device is configured to:
train the machine learning model based on a regression algorithm configured to support an open taxonomy or open vocabulary for relation and entity categorizations.

12. The apparatus of claim 8, wherein to prepare the training dataset, the at least one processing device is configured to:
select, using a caption classifier, reliable captions from the captions;
prompt the large language model to obtain subject-object-verb (SOV) triplets from sentences;
generate an SOV triplet dataset for the reliable captions; and
identify nouns in the SOV triplet dataset and corresponding bounding boxes in respective training images.

13. The apparatus of claim 8, wherein:
the machine learning model comprises an entity decoder and a relation decoder;
the entity decoder is configured to generate three distinct outcomes for each prompt associated with a corresponding training image; and
the relation decoder is configured to generate relation embeddings based on the three distinct outcomes until relation embeddings for a last prompt are generated.

14. The apparatus of claim 13, wherein each of the entity decoder and the relation decoder includes a two-way transformer configured to bi-directionally process and pass information such that prompts learn from the determined entity categories and the determined relations between the entities in the training images.

15. A method comprising:
obtaining, using at least one processing device of an electronic device, an image and associated prompts, the image including multiple entities;
processing, using the at least one processing device, the image and the associated prompts using a machine learning model, the machine learning model trained to map an encoded image and encoded prompts into one or more entity pairs, each entity pair including a subject and an object, the machine learning model also trained to determine a relation between the subject and the object in each entity pair; and
generating, using the at least one processing device, one or more entity categories and one or more relation categories associated with the image based on the one or more entity pairs and the relation associated with each of the one or more entity pairs.

16. The method of claim 15, wherein the machine learning model is trained by:
obtaining training images and captions;
preparing a training dataset based on the training images, the captions, and semantic knowledge of a large language model; and
training the machine learning model based on the training dataset.

17. The method of claim 16, wherein training the machine learning model comprises, for each training image and an associated prompt in the training dataset:
encoding the training image and the associated prompt;
decoding the encoded image and the encoded prompt;
mapping the decoded image and the decoded prompt into one or more entity pairs based on entity embeddings;
determining a category for a specified subject and a category for a specified object in each entity pair;
determining a corresponding bounding box for each of the specified subject and the specified object; and
determining a category for a relation between the specified subject and the specified object based on the entity embeddings.

18. The method of claim 16, wherein preparing the training dataset comprises:
selecting, using a caption classifier, reliable captions from the captions;
prompting the large language model to obtain subject-object-verb (SOV) triplets from sentences;
generating an SOV triplet dataset for the reliable captions; and
identifying nouns in the SOV triplet dataset and corresponding bounding boxes in respective training images.

19. The method of claim 15, wherein an associated prompt is trained to phrase questions such that the machine learning model points to an entity pair present in the image.

20. The method of claim 15, wherein the machine learning model is trained based on a regression algorithm configured to support an open taxonomy or open vocabulary for relation and entity categorizations.
